(19) United States
(12) Patent Application Publication
(10) Pub. No.: US 2017/0249288 A1
(43) Pub. Date: Aug. 31, 2017

(54) GRAMMAR GENERATION

(71) Applicant: FUJITSU LIMITED, Kawasaki-shi (JP)

(72) Inventor: Takuki KAMIYA, Palo Alto, CA (US)

(73) Assignee: FUJITSU LIMITED, Kawasaki-shi (JP)

(21) Appl. No.: 15/055,563

(22) Filed: Feb. 27, 2016

(51) Int. Cl. G06F 17/22

(52) U.S. Cl. CPC G06F 17/2247

(57) ABSTRACT

An extensible markup language schema definition (XSD) may be received. The XSD may include multiple elements, each having a complex type definition and an empty content model. A singleton empty content grammar may be generated. The singleton empty content grammar may be shared among the multiple elements. Multiple grammars may be generated based on the XSD. The multiple grammars may be associated with encoding and decoding extensible markup language (XML) documents based on the XSD to and from efficient XML interchange (EXI) streams. Each of the multiple grammars may correspond to an element of the multiple elements. Each of the multiple grammars may include the singleton empty content grammar. A device configured to encode or decode the XML documents to or from the EXI streams commits fewer resources than the device would commit if each of the multiple grammars included a separate content grammar rather than the singleton content grammar.

### FIELD

The embodiments discussed herein are related to grammar generation.

### BACKGROUND

Extensible markup language (XML) is a markup language that defines a set of rules for encoding documents in a plain-text format that may be both human-readable and machine-readable. One version of XML is defined in the XML 1.0 Specification produced by the World Wide Web Consortium (W3C) and dated Nov. 26, 2008, which is incorporated herein by reference in its entirety.

An XML schema is a description of a type of XML document, typically expressed in terms of constraints on the structure and content of documents of that type, above and beyond the basic syntactical constraints imposed by the XML 1.0 Specification itself. These constraints are generally expressed using some combination of rules governing the order of elements, Boolean predicates associated with the content, data types governing the content of elements and attributes, and more specialized rules such as uniqueness and referential integrity constraints. An XML document or set of XML documents may include an associated XML schema definition (XSD). The XSD may generally describe the XML schema associated with an XML document.

Efficient XML interchange (EXI) is a binary XML format in which XML documents are encoded in a binary data format rather than plain text. In general, using an EXI format may reduce the size and verbosity of XML documents, and may reduce the time and effort expended to parse XML documents. A formal definition of EXI is described in the EXI Format 1.0 Specification produced by the W3C and dated Feb. 11, 2014, which is incorporated herein by reference in its entirety. An XML document may be encoded in an EXI format as an EXI stream. Additionally, the EXI stream may be decoded to form an XML document similar to or the same as the original XML document.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, an extensible markup language schema definition (XSD) may be received. The XSD may include multiple elements, each having a complex type definition. A singleton content grammar may be generated. The singleton content grammar may be shared among the multiple elements. Multiple grammars may be generated based on the XSD. The multiple grammars may be associated with encoding and decoding extensible markup language (XML) documents based on the XSD to and from efficient XML interchange (EXI) streams. Each of the multiple grammars may correspond to an element of the multiple elements. Each of the multiple grammars may include the singleton content grammar. A device configured to encode or decode the XML documents to or from the EXI streams may commit fewer resources than the device would commit if each of the multiple grammars included a separate content grammar rather than the singleton content grammar.

The object and advantages of the embodiments will be realized and achieved at least by the elements, features, and combinations particularly pointed out in the claims. Both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a diagram of an example efficient extensible markup language interchange (EXI) processing system;

FIG. 2 is a flowchart of an example method that may be implemented by the system of FIG. 1;

FIG. 3 is a flowchart of another example method that may be implemented by the system of FIG. 1; and

FIG. 4 is a flowchart of another example method that may be implemented by the system of FIG. 1.

### DESCRIPTION OF EMBODIMENTS

Prior to encoding an extensible markup language (XML) document into an efficient XML interchange (EXI) stream or decoding an EXI stream into an XML document, an associated XML schema definition (XSD) may be normalized into grammars. The grammars may include rules used to predict specific sequences of the XML document. An algorithm for conventional generation of the grammars for an XSD is included in the EXI Format 1.0 Specification.

Conventionally, an individual content grammar may be generated for each of the elements of an XSD schema having an XSD complex type with an empty content model. For instance, for each of the elements of the XSD schema having an XSD complex type with empty content model, a corresponding EXI grammar may be generated, indicated by Typeᵢ, as follows:

Typeᵢ=H₀⊕H₁⊕ . . . Hₙ₋₁⊕Contentᵢ

Where ⊕ may represent a grammar concatenation operator. Furthermore, H₀⊕H₁⊕ . . . Hₙ₋₁ may represent an attribute grammar derived from attribute definitions, if any, for the associated element. Conventionally, Contentᵢ may be obtained by creating the following:
Contentᵢ:
   EE
      Thus, conventionally, a new Contentᵢ grammar may be generated for each element having an XSD complex type with the empty content model.

Furthermore, conventionally, an individual content grammar may be generated for each of the elements of an XSD schema having an XSD complex type with a simple type definition. For instance, for each of the elements of the XSD schema having an XSD complex type with the simple type definition, a corresponding EXI grammar may be generated, indicated by Typeᵢ, as follows:

Typeᵢ=H₀⊕H₁⊕ . . . Hₙ₋₁⊕Contentᵢ

Where ⊕ may represent a grammar concatenation operator. Furthermore, H₀ ⊕H₁⊕ . . . Hₙ₋₁ may represent an attribute grammar derived from attribute definitions, if any, for the associated element. Conventionally, Contentᵢ may be obtained by creating the following:
Content_{i,0}:
   CH [schema-type value] Content_{i,1}
Content_{i,1}:
   EE
      Thus, conventionally, a new Contentᵢ grammar may be generated for each element having an XSD complex type with the simple type definition.

According to some embodiments, a singleton grammar may be shared among certain complex element types. Sharing the singleton grammar among the certain complex element types may encourage space optimization. The space optimization may encourage a relatively more compact set of grammars. In some embodiments, a singleton content grammar may be shared among multiple XSD complex types with an empty content model. Alternately or additionally, a singleton content grammar may be shared among multiple XSD complex types with simple content.

Embodiments of the present invention will be explained with reference to the accompanying drawings.

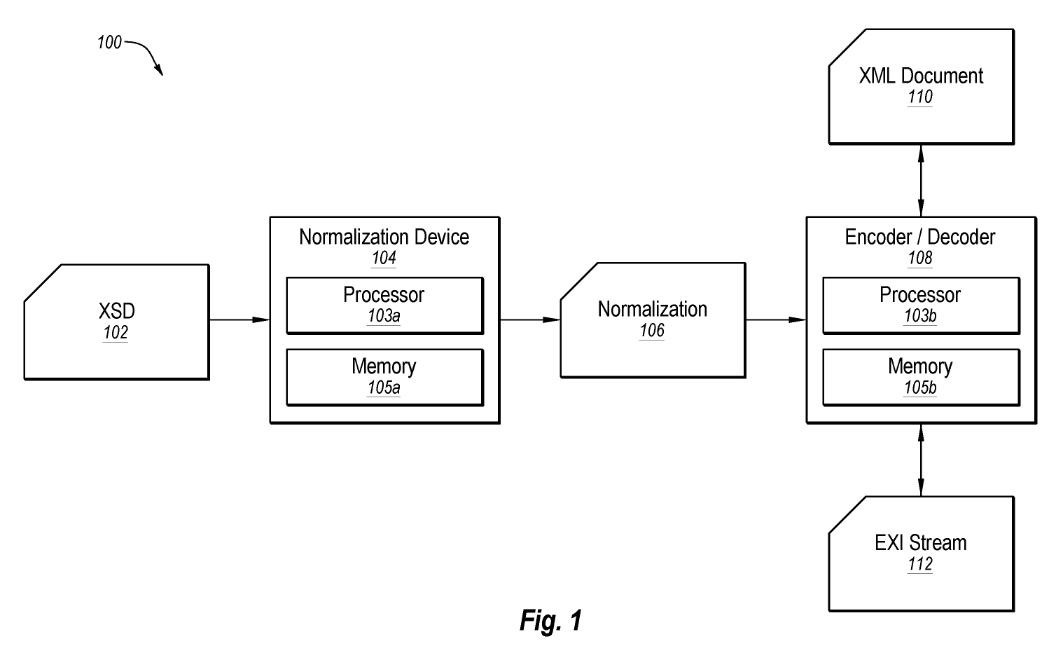

FIG. 1 is a block diagram of an example EXI processing system 100. The EXI processing system 100 includes a normalization device 104. The normalization device 104 may be configured to receive an XSD 102 and to output a normalization 106. The normalization 106 of the XSD 102 may be used, for example, in encoding and/or decoding an XML document.

The normalization device 104 may be configured to perform one or more operations of a grammar-generating process. According to some embodiments described herein, the normalization device 104 may generate a singleton content grammar and share the singleton content grammar among multiple elements having complex type definitions. Thus, in some instances, the XSD 102 including multiple elements may result in the normalization 106 including relatively fewer generated grammars, which may potentially reduce the amount of memory used to store grammar definitions.

The normalization 106 may be communicated to an encoder/decoder 108. An example encoder/decoder 108 may be included in the OpenEXI project hosted at SourceForge.net. The source code and documentation of the OpenEXI project as of the filing date of this application are incorporated herein by reference in their entirety. The encoder/decoder 108 may be configured to receive an XML, document 110 and to encode the XML document 110 as an EXI stream 112. Alternately or additionally, the EXI stream 112 may also be received by the encoder/decoder 108 and decoded as the XML document 110. An original XML document 110 and the XML document 110 generated by the encoder/decoder 108 may include substantially identical XML data. However, certain types of human-readable information, such as whitespace, comments, and/or processing instructions, may not be preserved by the encoder/decoder 108 depending on associated preservation settings of the encoder/decoder 108.

The normalization device 104 may include a processor 103a and a memory 105a. The encoder/decoder 108 may include a processor 103b and a memory 105b. The memory 105a and the memory 105b may include non-transitory computer-readable media. Instructions such as programming code executable by the processor 103a and the processor 103b may be encoded in the memory 105a and the memory 105b, respectively. When the instructions are executed by the processor 103a and/or the processor 103b, the normalization device 104 and/or the encoder/decoder 108 may perform operations related to and/or including the processes described herein.

The normalization device 104 and/or the encoder/decoder 108 may be employed in an embedded device and/or a device with limited memory capacity. Examples of embedded devices and/or devices with limited memory capacity include, but are not limited to, sensors, microcontrollers, and appliances, such as energy management controllers, automobile microcontrollers, smart meters, or the like. The devices may include network-connected devices, such as devices capable of functioning as Internet of Things (IoT) devices or the like. Providing a normalization device and/or an encoder/decoder capable of being employed in an embedded device and/or a device with limited memory capacity may improve such devices. For example, an embedded device and/or a device with limited memory capacity may be provided with EXI processing capability that may have been unavailable to such a device otherwise.

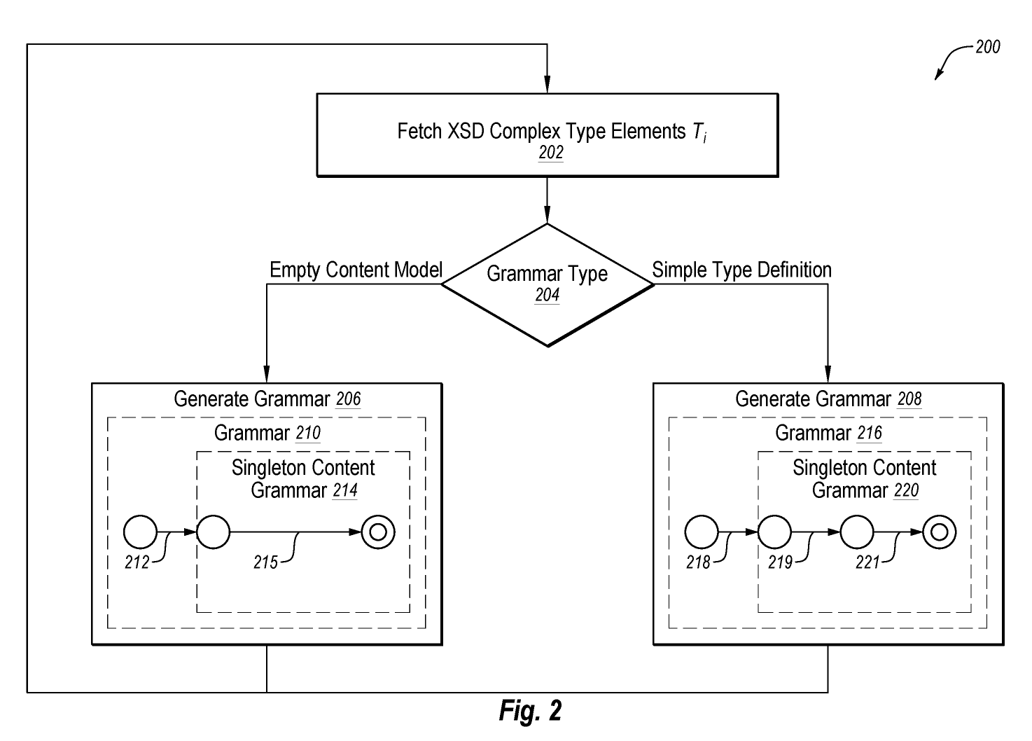

FIG. 2 is a flowchart of an example method 200 that may be implemented in the system 100 of FIG. 1. In some embodiments, the method 200 may be implemented by the normalization device 104 of FIG. 1. The method 200 may begin at block 202 by fetching an element having an XSD complex type, represented by Tᵢ. Multiple elements may have XSD complex types and thus the method 200 may be repeated.

The method 200 may continue at block 204 by determining a content type of the fetched element. If the content type includes an empty content model, the method 200 may continue at block 206. If the content type includes a simple content type, the method 200 may continue at block 208. In some embodiments, a grammar may be generated conventionally for elements having some other content type.

Regarding fetched elements having an empty content model, for example, an element A may have a complex type with an empty content model and may be defined as follows:

<xsd:complexType name=”A”>
</xsd:complexType>

At block 206, a grammar 210 may be generated for the fetched element having an empty content model. The grammar 210 may include an attribute grammar 212 derived from an attribute definition of the fetched element and a singleton content grammar 214. The singleton content grammar 214 for elements having an empty content model may be described herein as a singleton empty grammar. The singleton content grammar 214 may take the form of an automaton including an end of element event 215. If the singleton content grammar 214 does not exist when the method 200 reaches block 206, the singleton content grammar 214 may be generated. If the singleton content grammar 214 does exist, the previously generated singleton content grammar 214 may be employed.

By way of example, for each fetched element having an XSD complex type with an empty content model, a corresponding grammar 210 may be generated, indicated by Type_{empty}, as follows:

Type_{empty}=H₀⊕H₁⊕ . . . Hₙ₋₁⊕Content

Where ⊕ may represent a grammar concatenation operator. Furthermore, H₀ ⊕H₁⊕ . . . Hₙ₋₁ may be an example of the attribute grammar 212 derived from attribute definitions, if any, of the associated element.

Furthermore, Content may be an example of the singleton content grammar 214. Put another way, the grammar Content may not be created for every Tᵢ having an empty content model. In some embodiments, the grammar Content may be immutable given its position as the tail in the concatenation operation. Thus, for example, a single Content grammar may be generated for use with multiple XSD complex types with an empty content model in a schema.

Implementing the singleton content grammar 214 may reduce space requirements for storing grammars. Thus, for example, burdens associated with EXI implementations may be reduced. In some embodiments, the burdens associated with EXI implementations may be particularly reduced for embedded devices.

By way of example, an XSD schema having two complex types of empty content model may be defined, in part, as follows:

<xsd:complexType name=″ec1″/>
<xsd:complexType name=″ec2″/>

Furthermore, grammar generation for these two elements may be defined as follows:

```
<Grammar><!-- ee1 -->
  <Productions>
    <EndElement/>
  </Productions>
<ContentGrammar>1</ContentGrammar>
  <EmptyGrammar>. . .</EmptyGrammar>
</Grammar>
<Grammar><!-- ec2 -->
  <Productions>
    <EndElement/>
  </Productions>
<ContentGrammar>1</ContentGrammar>
  <EmptyGrammar>. . .</EmptyGrammar>
</Grammar>
```

The space employed for the grammar generation for these two elements may be 247 bytes. By comparison, the space employed in conventional grammar generation for these two elements may be 368 bytes.

Thus, for example, the reduction in grammar space for representing these two elements may be about 32.8% relative to the grammar space that may be used for representing these two elements conventionally. Put another way, in some embodiments, the amount of grammar space employed to represent elements having a complex type with an empty content model may be reduced by approximately one-third relative to conventional methods.

Regarding fetched elements having a simple content type, by way of example, an element B may have a complex type with a simple content type and may be defined as follows:

```
<xsd:complexType name=”B”>
  <xsd:simpleContent>
    <xsd:extension base=”xsd:string”>
      <xsd:attribute name=”a” type=”xsd:string”/>
    </xsd:extension>
  </xsd:simpleContent>
</xsd:complexType>
```

At block 208, a grammar 216 may be generated for the fetched element having a simple content type. The grammar 216 may include an attribute grammar 218 derived from an attribute definition of the fetched element and a singleton content grammar 220. The singleton content grammar 220 for elements having a simple content type may be described herein as a singleton simple content grammar. The singleton content grammar 220 may take the form of an automaton including a characters event 219 and an end of element event 221. If the singleton content grammar 220 does not exist when the method 200 reaches block 208, the singleton content grammar 220 may be generated. If the singleton content grammar 220 does exist, the previously generated singleton content grammar 220 may be employed.

By way of example, for each fetched element having an XSD complex type with simple content, a corresponding grammar 216 may be generated, indicated by Typeₛᵢₘₚₗₑ, as follows:

Typeₛᵢₘₚₗₑ=H₀⊕H₁⊕ . . . Hₙ₋₁⊕Content

Where ⊕ may represent a grammar concatenation operator. Furthermore, H₀ ⊕H₁⊕ . . . Hₙ₋₁ may be an example of the attribute grammar 218 derived from attribute definitions, if any, of the fetched element.

Furthermore, Content may be an example of the singleton content grammar 220. Put another way, the grammar Content may not be created for every Tᵢ having simple content. In some embodiments, the grammar Content may be immutable given its position as the tail in the concatenation operation. Thus, for example, a single Content grammar may be generated for use with multiple XSD complex types with simple content in a schema.

Implementing the singleton content grammar 220 may reduce space requirements for storing grammars. Thus, for example, burdens associated with EXI implementations may be reduced. In some embodiments, the burdens associated with EXI implementations may be particularly reduced for embedded devices.

By way of example, an XSD schema having a complex type of simple content may be defined, in part, as follows:

```
<xsd:complexType name=″sc1″>
  <xsd:simpleContent>
    <xsd:extension base=″xsd:string″>
      <xsd:attribute name=″a″ type=″xsd:string″/>
    </xsd:extension>
  </xsd:simpleContent>
</xsd:complexType>
<xsd:complexType name=″sc2″>
  <xsd:simpleContent>
    <xsd:extension base=″xsd:string″>
      <xsd:attribute name=″b″ type=″xsd:string″/>
    </xsd:extension>
  </xsd:simpleContent>
</xsd:complexType>
```

Furthermore, grammar generation for this element may be defined as follows:

```
<!-- sc1 -->
<Grammar>
  <Productions>
    <Attribute>0</Attribute>
    <Grammar>13</Grammar>
    <CharactersTyped/>
    <Grammar>1</Grammar>
  </Productions>
<ContentGrammar>3</ContentGrammar>
<EmptyGrammar>9</EmptyGrammar>
</Grammar>
<Grammar><! -- 13 -->
  <Productions>
    <CharactersTyped/>
    <Grammar>1</Grammar>
  </Productions>
<ContentGrammar>3</ContentGrammar>
</Grammar>
<! -- sc2 -->
<Grammar>
  <Productions>
    <Attribute>0</Attribute>
    <Grammar>13</Grammar>
    <CharactersTyped/>
    <Grammar>1</Grammar>
  </Productions>
<ContentGrammar>3</ContentGrammar>
<EmptyGrammar>9</EmptyGrammar>
</Grammar>
<Grammar><! -- 13 -->
  <Productions>
    <CharactersTyped/>
    <Grammar>1</Grammar>
  </Productions>
<ContentGrammar>3</ContentGrammar>
</Grammar>
```

The space employed for the grammar generation for these elements may be 554 bytes. By comparison, the space employed in conventional grammar generation for this element may be 920 bytes.

Thus, for example, the reduction in grammar space for representing this element may be about 39.7% relative to the grammar space that may be used for representing this element conventionally. Put another way, in some embodiments, the amount of grammar space employed to represent elements having a complex type with an empty content model may be reduced by approximately four-tenths relative to conventional methods.

For this and other processes and methods disclosed herein, the functions performed in the processes and methods may be implemented in differing order. Furthermore, the outlined operations are provided only as examples, and some of the operations may be optional, combined into fewer operations, or expanded into additional operations without detracting from the essence of the embodiments.

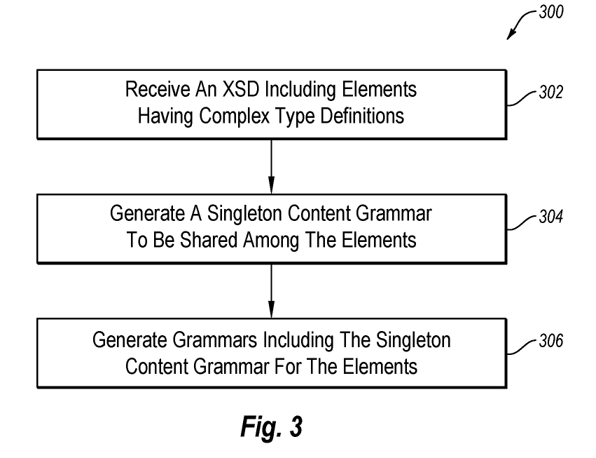

FIG. 3 is a flowchart of another example method 300 that may be implemented by the system of FIG. 1. The method 300 may begin at block 302 by receiving an XSD including elements, each having a complex type definition.

The method 300 may continue at block 304 by generating a singleton content grammar to be shared among the elements. In some embodiments, the elements may further include an empty content model and the singleton content grammar may include a singleton empty content grammar. The singleton empty content grammar may include an end of element event. In some embodiments, the elements may further include a simple type definition and the singleton content grammar may include a singleton simple content grammar. The singleton empty content grammar may include a characters event and an end of element event.

The method 300 may continue at block 306 by generating grammars based on the XSD. The grammars may be associated with encoding and decoding XML documents based on the XSD to and from EXI streams. Each of the grammars may correspond to an element and each of the grammars may include the singleton content grammar. In some embodiments, each of the grammars may further include an attribute grammar derived from an attribute definition associated with the element corresponding to the grammar.

For this and other processes and methods disclosed herein, the functions performed in the processes and methods may be implemented in differing order. Furthermore, the outlined operations are provided only as examples, and some of the operations may be optional, combined into fewer operations, or expanded into additional operations without detracting from the essence of the embodiments. For example, in some embodiments, the method 300 may further include encoding a first EXI stream from the XML document based on the XSD.

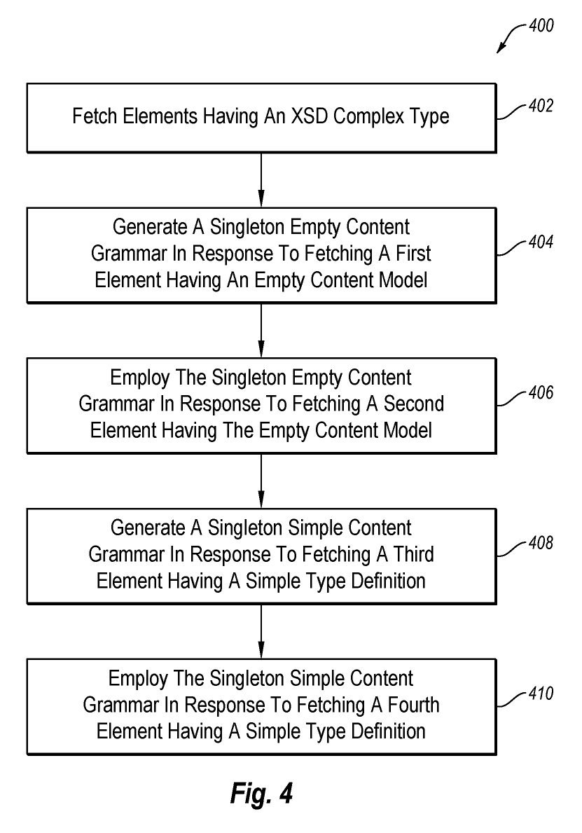

FIG. 4 is a flowchart of another example method 400 that may be implemented by the system of FIG. 1. The method 400 may begin at block 402 by fetching elements having an XSD complex type. The elements may include elements further having an empty content model. The elements may also include elements further having a simple type definition.

The method 400 may continue at block 404 by generating a singleton empty content grammar in response to fetching a first element having the XSD complex type and the empty content model. In some embodiments, the singleton empty content grammar may include an end of element event.

The method 400 may continue at block 406 by employing the singleton empty content grammar in response to fetching a second element having the XSD complex type and the empty content model.

The method 400 may continue at block 408 by generating a singleton simple content grammar in response to fetching a third element having the XSD complex type and the simple type definition. In some embodiments, the singleton simple content grammar may include a characters event and an end of element event.

The method 400 may continue at block 410 by employing the singleton simple content grammar in response to fetching a fourth element having the XSD complex type and the simple type definition.

For this and other processes and methods disclosed herein, the functions performed in the processes and methods may be implemented in differing order. Furthermore, the outlined operations are provided only as examples, and some of the operations may be optional, combined into fewer operations, or expanded into additional operations without detracting from the essence of the embodiments.

For example, in some embodiments, the method 400 may further include generating a first grammar associated with the first element. The first grammar may include a concatenation of an attribute grammar derived from attribute definitions associated with the first element and the singleton empty content grammar. The method 400 may further include generating a second grammar associated with the second element. The second grammar may include a concatenation of an attribute grammar derived from attribute definitions associated with the second element and the singleton empty content grammar. The method 400 may further include generating a third grammar associated with the third element. The third grammar may include a concatenation of an attribute grammar derived from attribute definitions associated with the third element and the singleton simple content grammar. The method 400 may further include generating a fourth grammar associated with the fourth element. The fourth grammar may include a concatenation of an attribute grammar derived from attribute definitions associated with the fourth element and the singleton simple content grammar.

The embodiments described herein may include the use of a special purpose or general purpose computer. For example, embodiments described with reference to the normalization device 104 of FIG. 1, the method 200 of FIG. 2, the method 300 of FIG. 3, and/or the method 400 of FIG. 4 may include the use of a special purpose or general purpose computer including various computer hardware or software modules, as discussed in greater detail below.

Embodiments described herein may be implemented using computer-readable media for carrying or having computer-executable instructions or data structures stored thereon. For example, instructions for performing one or more of the steps described with reference to the method 200 of FIG. 2, the method 300 of FIG. 3, and/or the method 400 of FIG. 4 may be stored on computer-readable media. Such computer-readable media may be any available media that may be accessed by a general purpose or special purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions may include, for example, instructions and data which cause a general purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general purpose hardware (e.g., computer-readable media, processing devices, etc.) of the computing system. Thus, for example, different modules may perform one or more steps of the method 200 of FIG. 2, the method 300 of FIG. 3, and/or the method 400 of FIG. 4.

By way of example, a receiver module may receive an XSD including multiple elements each having a complex type definition as described herein. Alternately or additionally, a grammar generation module may generate a singleton content grammar to be shared among the multiple elements. Alternately or additionally, the grammar generation module may generate multiple grammars based on the XSD. The multiple grammars may be associated with encoding and decoding XML documents based on the XSD to and from EXI streams. Each of the multiple grammars may correspond to an element of the multiple elements and each of the multiple grammars may include the singleton content grammar. Alternate or additional modules and/or components may perform other processes described herein.

In some embodiments, the different components, modules, engines, and services described herein may be implemented as objects or processes that execute on the computing system (e.g., as separate threads). While some of the system and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present inventions have been described in detail, it should be understood that the various changes, substitutions, and alterations could be made hereto without departing from the spirit and scope of the invention.

What is claimed is:

1. A method comprising:
receiving an extensible markup language schema definition (XSD) including a plurality of elements each having a complex type definition;
generating a singleton content grammar to be shared among the plurality of elements; and
generating a plurality of grammars based on the XSD, the plurality of grammars associated with encoding and decoding extensible markup language (XML) documents based on the XSD to and from efficient XML interchange (EXI) streams, each of the plurality of grammars corresponding to an element of the plurality of elements, and each of the plurality of grammars including the singleton content grammar, such that a device configured to encode or decode the XML documents to or from the EXI streams commits fewer resources to the EXI stream encoding or decoding than the device would commit if each of the plurality of grammars included a separate content grammar rather than the singleton content grammar.

2. The method of claim 1, further comprising encoding a first EXI stream from the XML document based on the XSD.

3. The method of claim 1, wherein each of the plurality of grammars further includes an attribute grammar derived from an attribute definition associated with the element of the plurality of elements corresponding to the grammar.

4. The method of claim 3, wherein each of the plurality of grammars includes a concatenation of the attribute grammar and the singleton content grammar.

5. The method of claim 1, wherein the plurality of elements each further includes an empty content model and the singleton content grammar includes a singleton empty content grammar.

6. The method of claim 5, wherein the singleton empty content grammar includes an end of element event.

7. The method of claim 1, wherein the plurality of elements each further includes a simple type definition and the singleton content grammar includes a singleton simple content grammar.

8. The method of claim 7, wherein the singleton simple content grammar includes a characters event and an end of element event.

9. A method comprising:
fetching a plurality of elements having an extensible markup language schema definition (XSD) complex types, the plurality of elements including:
a plurality of elements further having an empty content model; and
a plurality of elements further having a simple type definition;
generating a singleton empty content grammar in response to fetching a first element having the XSD complex type and the empty content model;
employing the singleton empty content grammar in response to fetching a second element having the XSD complex type and the empty content model;
generating a singleton simple content grammar in response to fetching a third element having the XSD complex type and the simple type definition; and
employing the singleton simple content grammar in response to fetching a fourth element having the XSD complex type and the simple type definition, such that a device configured to encode or decode extensible markup language (XML) documents based on the XSD to and from efficient XML interchange (EXI) streams streams commits fewer resources to the EXI stream encoding or decoding than the device would commit if a plurality of separate empty content grammars were generated rather than the singleton empty content grammar and a plurality of separate simple content grammars were generated rather than the singleton simple content grammar.

10. The method of claim 9, wherein the singleton empty content grammar includes an end of element event.

11. The method of claim 9, wherein the singleton simple content grammar includes a characters event and an end of element event.

12. The method of claim 9, further comprising:
generating a first grammar associated with the first element, the first grammar a concatenation of an attribute grammar derived from attribute definitions associated with the first element and the singleton empty content grammar;
generating a second grammar associated with the second element, the second grammar a concatenation of an attribute grammar derived from attribute definitions associated with the second element and the singleton empty content grammar;
generating a third grammar associated with the third element, the third grammar a concatenation of an attribute grammar derived from attribute definitions associated with the third element and the singleton simple content grammar; and
generating a fourth grammar associated with the fourth element, the fourth grammar a concatenation of an attribute grammar derived from attribute definitions associated with the fourth element and the singleton simple content grammar.

13. A non-transitory computer-readable medium having encoded therein program code executable by a processor to perform operations comprising:
receiving an extensible markup language schema definition (XSD) including a plurality of elements each having a complex type definition;
generating a singleton content grammar to be shared among the plurality of elements; and
generating a plurality of grammars based on the XSD, the plurality of grammars associated with encoding and decoding extensible markup language (XML) documents based on the XSD to and from efficient XML, interchange (EXI) streams, each of the plurality of grammars corresponding to an element of the plurality of elements, and each of the plurality of grammars including the singleton content grammar, such that a device configured to encode or decode the XML documents to or from the EXI streams commits fewer resources of the non-transitory computer-readable medium to the EXI stream encoding or decoding than the device would commit if each of the plurality of grammars included a separate content grammar rather than the singleton content grammar.

14. The non-transitory computer-readable medium of claim 13, further comprising encoding a first EXI stream from the XML document based on the XSD.

15. The non-transitory computer-readable medium of claim 13, wherein each of the plurality of grammars further includes an attribute grammar derived from an attribute definition associated with the element of the plurality of elements corresponding to the grammar.

16. The non-transitory computer-readable medium of claim 15, wherein each of the plurality of grammars includes a concatenation of the attribute grammar and the singleton content grammar.

17. The non-transitory computer-readable medium of claim 13, wherein the plurality of elements each further includes an empty content model and the singleton content grammar includes a singleton empty content grammar.

18. The non-transitory computer-readable medium of claim 17, wherein the singleton empty content grammar includes an end of element event.

19. The non-transitory computer-readable medium of claim 13, wherein the plurality of elements each further includes a simple type definition and the singleton content grammar includes a singleton simple content grammar.

20. The non-transitory computer-readable medium of claim 19, wherein the singleton simple content grammar includes a characters event and an end of element event.
